(19) United States
(12) Patent Application Publication
(10) Pub. No.: US 2025/0369887 A1
(43) Pub. Date: Dec. 4, 2025

(54) ELECTROPHORESIS DEVICE AND CAPILLARY ARRAY

(71) Applicant: Hitachi High-Tech Corporation, Tokyo (JP)

(72) Inventors: Tomonari MORIOKA, Tokyo (JP); Hitoshi MIYATA, Tokyo (JP); Shuhei YAMAMOTO, Tokyo (JP); Ayaka OKUNO, Tokyo (JP); Motohiro YAMAZAKI, Tokyo (JP); Takehiko SHIBASAKI, Tokyo (JP)

(21) Appl. No.: 18/876,238

(22) PCT Filed: Aug. 29, 2022
(86) PCT No.: PCT/JP2022/032425

§ 371 Date: Dec. 18, 2024

(51) Int. Cl. G01N 21/64; G01N 21/03

(52) U.S. Cl. CPC G01N 21/6486; G01N 2021/0346; G01N 2021/6463

(57) ABSTRACT

In order to provide an electrophoresis device that is capable of reducing a noise signal caused by foreign matter present around an excitation light irradiation section of a capillary array, the electrophoresis device includes: a capillary array in which capillaries to be used for electrophoresis of a sample are arrayed in a plane; an excitation light source that emits excitation light to the capillary array; and a fluorescence measurement unit that measures fluorescence induced from the capillary array. The capillary array has a sealed structure in which a portion located around an excitation light irradiation section that is irradiated with the excitation light is filled with air.

### TECHNICAL FIELD

The present invention relates to an electrophoresis device that separates and analyzes a sample such as DNA, and a capillary array mounted on the electrophoresis device.

### BACKGROUND ART

An electrophoresis device separates a fluorescently labeled sample by electrophoresis and analyzes the sample by detecting fluorescence induced by irradiation with excitation light. Particularly in a case where a small amount of a sample such as DNA is analyzed, the sample filled together with a separation medium in a quartz glass capillary is separated by electrophoresis. To analyze a plurality of samples concurrently, a capillary array in which capillaries are arrayed in a plane is irradiated with excitation light along an array direction. However, at an interface between a capillary and air, the excitation light is dispersed and reflected due to the difference in refractive index between the capillary and the air. Therefore, the excitation light that passes through the capillary array is attenuated exponentially, and fluorescence emitted by the sample also weakens.

Patent Literature 1 discloses that, to suppress attenuation of excitation light that passes through a capillary array, a light transmission medium that is a liquid or solid with a refractive index greater than that of air but not greater than that of water is interposed in a space between capillaries through which the excitation light passes.

### CITATION LIST

### Patent Literature

Patent Literature 1: Japanese Unexamined Patent Application Publication No. 2010-96778.

### SUMMARY OF INVENTION

### Technical Problem

However, Patent Literature 1 does not give sufficient consideration to foreign matter present around a portion irradiated with the excitation light. Raman scattered light emitted from the light transmission medium interposed between the capillaries becomes a noise signal for the fluorescence emitted by the sample. Thus, the Raman scattered light has a large sensitivity limit, making it impossible to detect a small amount of fluorescence from the sample. In addition, fluorescence emitted from floating dust in the atmosphere that is attracted to a charged capillary during electrophoresis also becomes a noise signal. Further, when an adhesive used to fix the capillary flows into an excitation light irradiation section, fluorescence emitted from the adhesive becomes a noise signal.

Therefore, an object of the present invention is to provide an electrophoresis device and a capillary array that are capable of reducing a noise signal caused by foreign matter present around an excitation light irradiation section of a capillary array.

### Solution to Problem

In order to achieve the above object, an electrophoresis device of the present invention includes: a capillary array in which capillaries to be used for electrophoresis of a sample are arrayed in a plane; an excitation light source that emits excitation light to the capillary array; and a fluorescence measurement unit that measures fluorescence induced from the capillary array. The capillary array has a sealed structure in which a portion located around an excitation light irradiation section that is irradiated with the excitation light is filled with air.

Further, the electrophoresis device of the present invention includes: a capillary array in which capillaries to be used for electrophoresis of a sample are arrayed in a plane; an excitation light source that emits excitation light to the capillary array; and a fluorescence measurement unit that measures fluorescence induced from the capillary array. In a substrate on which the capillary array is arranged and fixed by an adhesive, a groove is provided between an application section to which the adhesive is applied and an excitation light irradiation section that is irradiated with the excitation light.

Further, in a capillary array of the present invention, capillaries to be used for electrophoresis of a sample are arrayed in a plane, and the capillary array has a sealed structure in which a portion located around an excitation light irradiation section that is irradiated with excitation light is filled with air.

### Advantageous Effects of Invention

According to the present invention, it is possible to provide an electrophoresis device and a capillary array that are capable of reducing a noise signal caused by foreign matter present around an excitation light irradiation section of a capillary array.

### BRIEF DESCRIPTION OF DRAWINGS

FIG. 1 is a diagram illustrating an example of an overall configuration of an electrophoresis device according to a first embodiment.

FIG. 2 is a diagram illustrating an example of an overall configuration of a capillary array according to the first embodiment.

FIG. 3 is a diagram illustrating an example of a configuration of a detector according to the first embodiment.

FIG. 4 is a diagram illustrating members forming the detector according to the first embodiment.

FIG. 5 is a diagram illustrating a cross-section of the detector according to the first embodiment.

FIG. 6 is a diagram illustrating a surplus adhesive in the detector according to the first embodiment.

FIGS. 7 are diagrams explaining an effect of a noise signal.

FIG. 8 is a diagram illustrating an example of a configuration of a detector according to a second embodiment.

FIG. 9 is a diagram illustrating an example of a configuration of a detector according to a third embodiment.

FIG. 10 is a diagram illustrating a cross-section of the detector according to the third embodiment.

FIG. 11 is a diagram illustrating an example of a configuration of a detector according to a fourth embodiment.

FIG. 12 is a diagram illustrating an example of an overall configuration of an electrophoresis device according to the fourth embodiment.

### DESCRIPTION OF EMBODIMENTS

Hereinafter, embodiments of an electrophoresis device according to the present invention will be described with reference to the accompanying drawings. An electrophoresis device separates a fluorescently labeled sample by electrophoresis and analyzes the sample by detecting fluorescence induced by irradiation with excitation light.

### First Embodiment

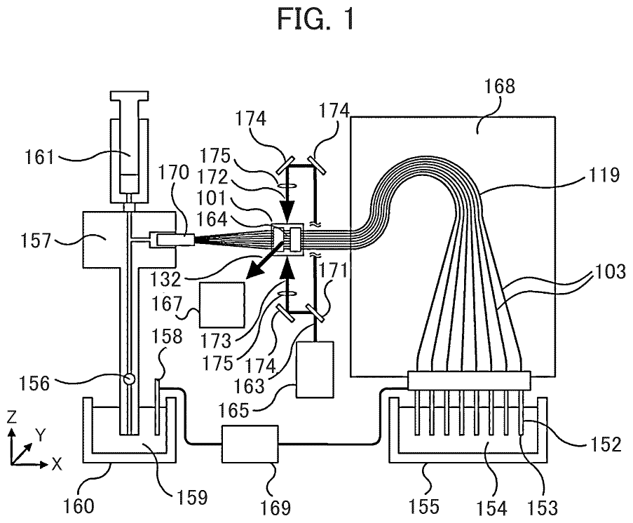

An example of an overall configuration of an electrophoresis device according to a first embodiment will be described with reference to FIG. 1. The electrophoresis device includes a light source 165, a fluorescence measurement unit 167, a capillary array 119, a constant-temperature bath 168, a voltage source 169, an anode-side buffer solution container 160, a cathode-side buffer solution container 155, and a gel block 157. Each component will be described below.

The light source 165 is a device that irradiates the capillary array 119 with excitation light, and is, for example, a laser light source. Excitation light 163 emitted from the light source 165 is split into two excitation lights 172 and 173 by a half mirror 171. After traveling directions of the excitation lights 172 and 173 are changed by mirrors 174, the excitation light 172 and 173 are focused by condensing lenses 175, and an excitation light irradiation section 164 is irradiated with the excitation lights 172 and 172 from both upper and lower sides substantially coaxially. The excitation light irradiation section 164 may be irradiated with either the excitation light 172 or the excitation light 173.

The fluorescence measurement unit 167 is a device that measures fluorescence 132 induced in the capillary array 119 by the irradiation with the excitation lights 172 and 173, and includes, for example, a CCD camera, a diffraction grating, and a lens. The fluorescence measurement unit 167 is arranged in a direction orthogonal to an array surface of the capillary array 119.

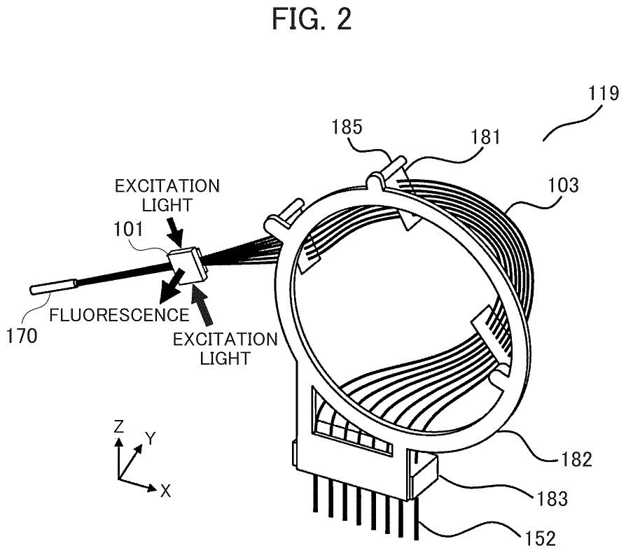

The capillary array 119 includes arrayed capillaries 103 to be used for electrophoresis of a sample such as a DNA molecule, and is a consumable component that is replaced as necessary. A configuration of the capillary array 119 will be described with reference to FIG. 2. The capillary array 119 includes the plurality of capillaries 103, a capillary head 170, a detector 101, and an electrode holder 183. The number of capillaries 103 is not limited to 8 exemplified in FIG. 2.

The capillary 103 is a capillary tube to be used for electrophoresis of a sample, and is formed by coating an outer surface of a glass tube with polyimide of several tens of μm for reinforcement. The glass tube has an inner diameter of several tens to hundreds of um and an outer diameter of several hundreds of μm. The capillaries 103 are filled with a separation medium, which is an electrolyte solution, together with the sample. The separation medium may contain a polymer gel, a polymer, or the like.

The plurality of capillaries 103 are held by a capillary holder 182 having an annular shape. Since the capillaries 103 are held by the capillary holder 182, it is easy to carry the capillary array 119. The capillary holder 182 is provided with separators 181 via respective separator holders 185. Each of the separators 181 is provided with the same number of holes as the number of capillaries 103, the holes of each of the separators 181 are arranged at equal intervals, and each of the capillaries 103 is inserted in a respective one of the holes. Since the capillaries 103 are inserted in the holes of the separators 181, distances between the capillaries 103 are kept equal, and it is easy to manage the temperatures of the capillaries 103.

The electrode holder 183 holds cathodes 152 that are metal hollow electrodes. The number of the cathodes 152 is equal to the number of capillaries 103. One end of each of the capillaries 103 penetrates through a respective one of the cathodes 152, and the cathodes 152 are fixed to the capillaries 103 with an adhesive or the like. The capillary head 170 is a resin member that binds the other ends of the plurality of capillaries 103.

The detector 101 is a portion where the detector 101 is irradiated with the excitation lights 172 and 173 from the light source 165, and fluorescence is measured by the fluorescence measurement unit 167. At the detector 101, polyimide on outer surfaces of the capillaries 103 is removed so that the irradiation with the excitation lights and the measurement of fluorescence are not hindered. In addition, at the detector 101, the plurality of capillaries 103 are arrayed in a plane.

Return to the description of FIG. 1. The constant-temperature bath 168 is a temperature adjuster that maintains the capillary array 119 at a predetermined temperature, for example, 60° C.

The voltage source 169 is a power supply that applies a voltage to both ends of the capillary array 119, and has an anode connected to the capillary head 170 side, and a cathode connected to the electrode holder 183 side. The anode-side buffer solution container 160 and the cathode-side buffer solution container 155 are containers in which buffer solutions 159 and 154 that supply electric charges at the time of electrophoresis are contained. The anode-side buffer solution container 160 is arranged on the capillary head 170 side, while the cathode-side buffer solution container 155 is arranged on the electrode holder 183 side.

The gel block 157 includes a tube to which the capillary head 170 is connected. An upper end of the tube of the gel block 157 is connected to a syringe 161, and a lower end of the tube is immersed in the buffer solution 159 contained in the anode-side buffer solution container 160. By operating a valve 156 provided in the middle of the tube, and the syringe 161, the separation medium is injected into the capillaries 103.

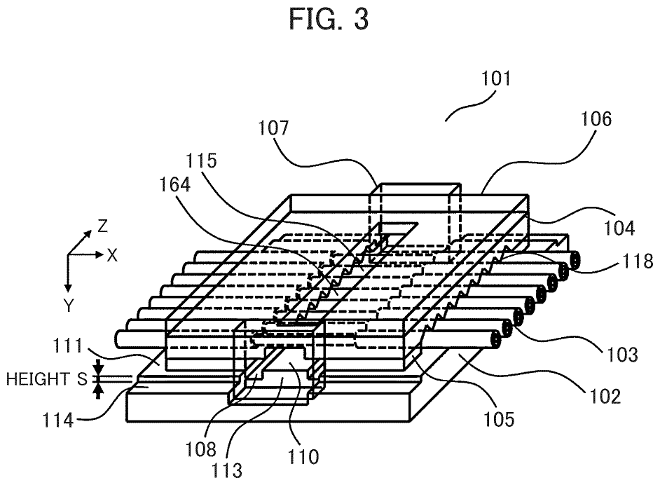

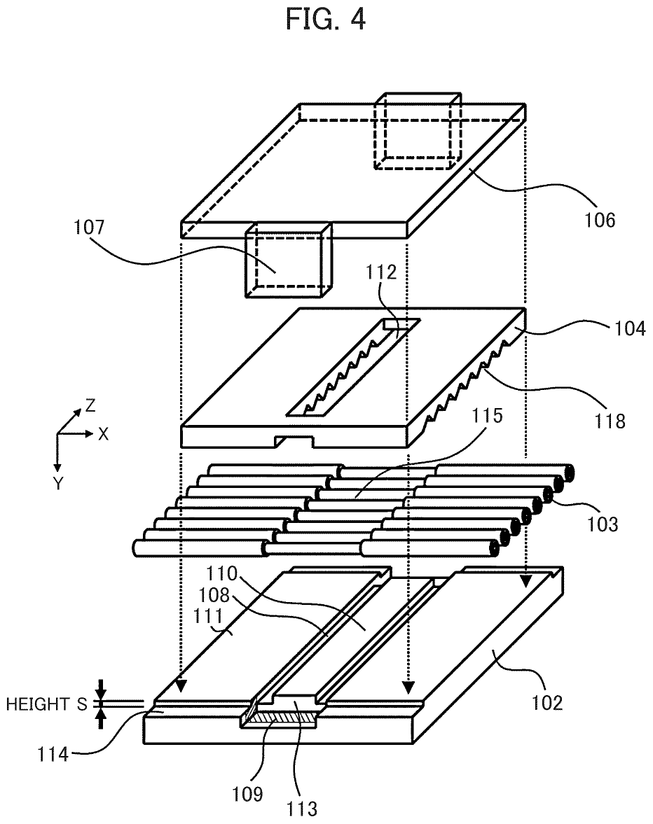

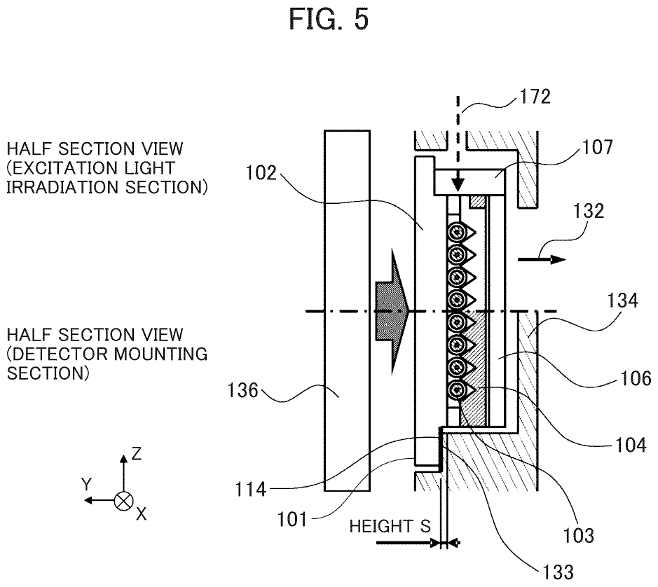

The detector 101 according to the first embodiment will be described with reference to FIGS. 3, 4, and 5. FIG. 3 is a perspective view illustrating a state in which members forming the detector 101 are assembled, and FIG. 4 is a perspective view illustrating a state in which the respective members are separated. FIG. 5 illustrates an excitation light irradiation section and a detector mounting section as a cross-sectional view of the detector 101.

The detector 101 includes the plurality of capillaries 103, a substrate 102, a fixed plate 104, and a light transmitting plate 106. The plurality of capillaries 103 are arrayed on the substrate 102. The fixed plate 104 and the light transmitting plate 106 are sequentially disposed on the plurality of capillaries 103. Each of the substrate 102 and the fixed plate 104 is constituted by a member that shields light. By bonding the substrate 102 and the fixed plate 104 with an adhesive 105, the plurality of capillaries 103 are fixed onto the substrate 102. The light transmitting plate 106 is constituted by a member through which light passes.

The substrate 102 has a capillary array surface 111 serving as a reference flat surface, and the plurality of capillaries 103 are arrayed on the capillary array surface 111 so as to be in contact with the capillary array surface 111. In the fixed plate 104, positioning grooves 118 having a V shape or the like may be formed at equal intervals. By fitting the capillaries 103 into the positioning grooves 118, the capillaries 103 are arranged at desired intervals. In a case where the capillaries 103 are arranged in close contact with each other on the substrate 102, that is, in a case where the diameters of the capillaries 103 are equal to intervals at which the capillaries 103 are arrayed, the positioning grooves 118 may not be formed in the fixed plate 104.

At the excitation light irradiation section 164 that is a portion irradiated with the excitation lights 172 and 173, a quartz tube 115 is exposed without being covered with the capillaries 103. In the fixed plate 104, a fluorescence passage opening 112 through which fluorescence 132 from the sample passes is provided. After passing through the fluorescence passage opening 112, the fluorescence 132 passes through the light transmitting plate 106 and reaches the fluorescence measurement unit 167.

A light transmitting member 107 provided on the light transmitting plate 106 is fitted into a recess 109 provided in the substrate 102, and the light transmitting plate 106 is assembled onto the substrate 102 by applying an adhesive or the like to a portion shaded in FIG. 4. The light transmitting member 107 is a member through which the excitation lights 172 and 173 with which the quartz tube 115 is to be irradiated pass. Since the light transmitting member 107 is fitted into the recess 109, and the light transmitting plate 106 is assembled onto the substrate 102, a portion located around the quartz tube 115 of the excitation light irradiation section 164 is a sealed structure filled with air. Since the portion located around the quartz tube 115 of the excitation light irradiation section 164 is filled with air, foreign matter that emits Raman scattered light is not present in the excitation light irradiation section 164 and thus it is possible to suppress a noise signal. In addition, since the portion located around the quartz tube 115 is the sealed structure, floating dust and the like in the atmosphere do not adhere to the quartz tube 115 and thus it is possible to suppress a noise signal.

When scattered lights of the excitation lights 172 and 173 that have passed through the light transmitting member 107 are incident on the adhesive applied to the portion shaded in FIG. 4, the adhesive emits fluorescence serving as a noise signal. Therefore, a non-light transmitting member through which light does not pass is used as a constituent member of the substrate 102, it is possible to suppress the arrival of the fluorescence emitted by the adhesive at the excitation light irradiation section 164. A protruding light shielding section 113 having a protruding shape is disposed on the substrate 102, and thus it is possible to more suppress the arrival of the fluorescence emitted by the adhesive at the excitation light irradiation section 164.

A detector installation surface 114 having a step with a height S with respect to the capillary array surface 111 may be provided at four corners of the substrate 102. The detector installation surface 114 is a surface that comes into contact with a device alignment surface 133 of a detector fixing mechanism 134 illustrated in FIG. 5. The detector fixing mechanism 134 is provided in the electrophoresis device, and a substrate presser 136 is used to cause the detector installation surface 114 to come into contact with the device alignment surface 133. In a multi-focus method in which the capillary array in which the capillaries are arrayed in a plane is irradiated with the excitation lights along an array direction, the efficiency of irradiation of each capillary 103 with laser is determined based on the diameter of the quartz tube 115, intervals at which the capillaries 103 are arrayed, and a refractive index of polymer filled in the capillaries. Thus, a single capillary array electrophoresis device can analyze a sample using a plurality of analysis applications by using various capillary arrays 119 with different values of heights S depending on the analysis purpose.

An adhesive groove 108 may be provided in the substrate 102. An adhesive used to fix the capillaries 103 to the substrate 102 may flow to the excitation light irradiation section 164 due to a capillary action, and the adhesive that has flowed into the excitation light irradiation section 164 emits fluorescence serving as a noise signal. Therefore, the adhesive groove 108 that is a groove for preventing the flow of the adhesive to the excitation light irradiation section 164 is provided in the substrate 102. For example, the adhesive groove 108 is provided so as to extend in the direction in which the capillaries 103 are arrayed.

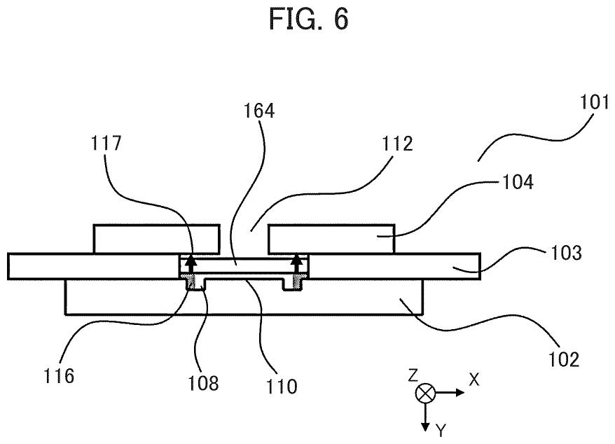

The adhesive groove 108 will be described with reference to FIG. 6. FIG. 6 is a cross-sectional view of the detector 101, and the light transmitting plate 106 is omitted. The adhesive groove 108 is provided between a portion to which the adhesive used to fix the capillaries 103 is applied and the excitation light irradiation section 164. A portion of the adhesive used to fix the capillaries 103 becomes surplus adhesive 116 and tries to flow to the excitation light irradiation section 164 but accumulates in the adhesive groove 108. Thus, the surplus adhesive 116 does not reach an excitation light neighboring surface 110. The adhesive groove 108 may not be formed from end to end of the substrate 102, and may be provided at the portion to which the adhesive is applied.

In addition, the adhesive groove 108 is covered in a region of the fixed plate 104 where the fluorescence passage opening 112 is not formed. Therefore, adhesive fluorescence 117 emitted from the surplus adhesive 116 accumulated in the adhesive groove 108 does not reach the fluorescence measurement unit 167. That is, the fixed plate 104 serving as a light shielding section that shields light is provided between the adhesive groove 108 and the fluorescence measurement unit 167, and thus the adhesive fluorescence 117 serving as a noise signal is shielded.

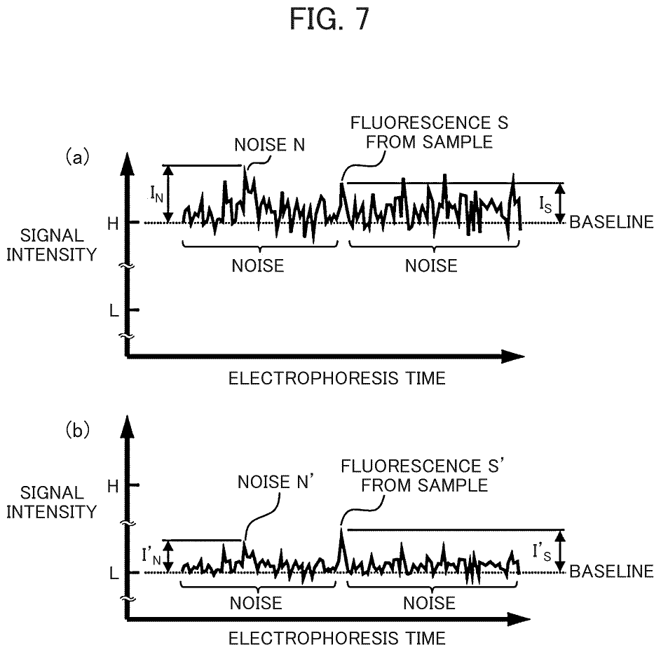

Effects obtained in the first embodiment will be described with reference to FIGS. 7. FIG. 7(a) illustrates an example of a measurement signal when a noise signal cannot be reduced sufficiently, and FIG. 7(b) illustrates an example of a measurement signal by the detector 101 according to the first embodiment. Each vertical axis in FIGS. 7 indicates a signal intensity measured by the fluorescence measurement unit 167, each horizontal axis in FIGS. 7 indicates electrophoresis time, and the signal intensity is magnified and displayed in the vertical axis direction.

When the noise signal cannot be reduced sufficiently, as exemplified in FIG. 7(a), a baseline intensity increases to H, a range I_{N} of a signal intensity of noise N increases, and a signal intensity I_{S} of fluorescence S from the sample is in the range I_{N} of the noise N and cannot be detected.

On the other hand, when the noise signal can be reduced by the detector 101 according to the first embodiment, as exemplified in FIG. 7(b), the baseline intensity decreases to L, a range I_{N}′ of a signal intensity of noise N′ decreases, and a signal intensity I_{S}′ of fluorescence S′ from the sample is out of the range I_{N} of the noise N′ and can be detected. Note that the fluorescence S from the sample does not depend on the baseline intensity and that the signal intensity I_{S} and the signal intensity I_{S}′ are equal.

Therefore, according to the first embodiment, it is possible to reduce a noise signal caused by foreign matter present around the excitation light irradiation section 164. As a result, a sensitivity limit decreases and it is possible to detect fluorescence from the sample even in a case where the fluorescence is weak.

### Second Embodiment

The first embodiment describes the case where the height of the excitation light neighboring surface 110 of the substrate 102 is substantially the same as that of the capillary array surface 111, and the detector installation surface 114 has the step with the height S with respect to the capillary array surface 111. A second embodiment will describe a case where an excitation light neighboring surface 210 of a substrate 202 is formed at a location where the excitation light neighboring surface 210 is lower than a capillary array surface 211 by a height T and the height of a detector installation surface 214 is the same as that of the capillary array surface 211.

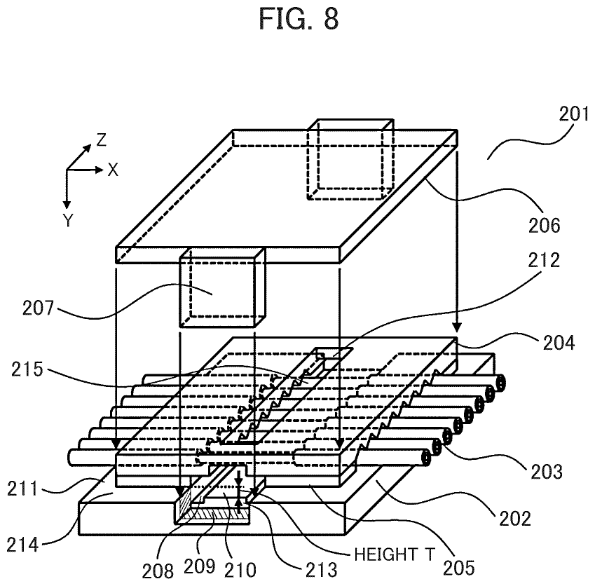

A detector 201 according to the second embodiment will be described with reference to FIG. 8. FIG. 8 is a perspective view illustrating a state in which the substrate 202 forming the detector 201, a plurality of capillaries 203, and a fixed plate 204 are assembled and a light transmitting plate 206 is separated. As in the first embodiment, the substrate 202 includes the capillary array surface 211, the detector installation surface 214, an adhesive groove 208, a recess 209, and a protruding light shielding section 213. As in the first embodiment, the fixed plate 204 has a fluorescence passage opening 212 and is bonded to the substrate 202 by an adhesive 205. Further, as in the first embodiment, the light transmitting plate 206 includes a light transmitting member 207.

In the substrate 202 exemplified in FIG. 8, the height of the detector installation surface 214 is the same as that of the capillary array surface 211, such a step having a height S as described in the first embodiment does not need to be processed, and thus it is easy to make the substrate 202.

In addition, in a multi-focus method, by tilting excitation lights 172 and 173 emitted to a quartz tube 215 with respect to the excitation light neighboring surface 210, one of the excitation lights may be prevented from passing along a route of the other of the excitation lights and returning to the light source 165. The excitation lights 172 and 173 tilted with respect to the excitation light neighboring surface 210 may be blocked by the substrate 202. However, the excitation light neighboring surface 210 is formed at a position where the excitation light neighboring surface 210 is lower than the capillary array surface 211 by the height T, and thus the excitation lights 172 and 173 are not blocked by the substrate 202.

Even in a case where the height of the excitation light neighboring surface 110 is substantially the same as that of the capillary array surface 111 as in the first embodiment, a slope may be provided at an end of the protruding light shielding section 113 such that the excitation lights 172 and 173 are not blocked by the substrate 102.

Also in the second embodiment, a portion located around the quartz tube 215 of the excitation light irradiation section 164 is a sealed structure filled with air, and thus it is possible to reduce a noise signal caused by foreign matter present around the excitation light irradiation section 164 and a sensitivity limit decreases as in the first embodiment.

### Third Embodiment

The first embodiment describes the case where the plurality of capillaries 103 are fixed by the fixed plate 104 adhered to the substrate 102. A third embodiment will describe a case where a plurality of capillaries 303 are fixed by a light transmitting plate 306.

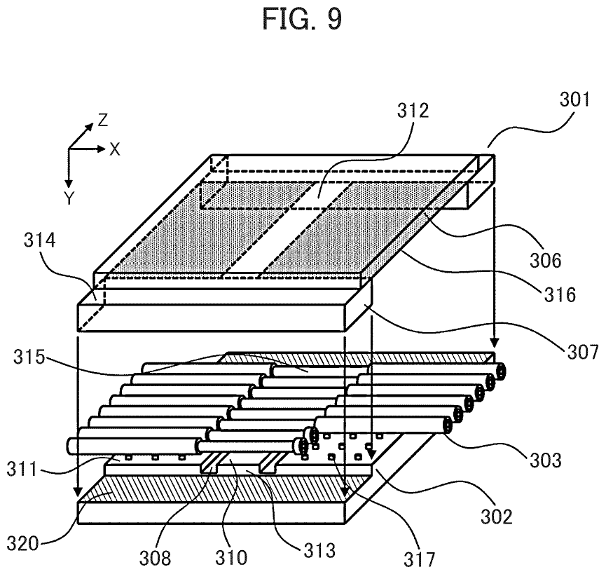

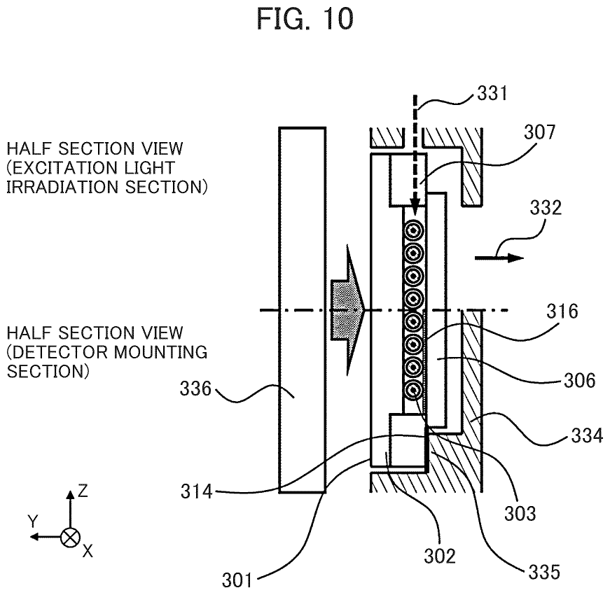

A detector 301 according to the third embodiment will be described with reference to FIGS. 9 and 10. FIG. 9 is a perspective view illustrating a state in which a substrate 302 forming the detector 301, and the plurality of capillaries 303 are assembled and the light transmitting plate 306 is separated. In addition, FIG. 10 illustrates an excitation light irradiation section and a detector mounting section as a cross-sectional view of the detector 301. As in the first embodiment, the substrate 302 has a capillary array surface 311, an adhesive groove 308, and a protruding light shielding section 313.

The plurality of capillaries 303 arrayed on the capillary array surface 311 of the substrate 302 exemplified in FIG. 9 are adhered and fixed by the light transmitting plate 306. A light shielding member 316 is coated by vapor deposition or the like on a lower surface of the light transmitting plate 306, that is, on a surface in contact with the plurality of capillaries 303. However, the light shielding member 316 is not coated in a region of a fluorescence passage opening 312.

Positioning guides 317 are provided on the capillary array surface 311 of the substrate 302. The positioning guides 317 are formed by hardening an adhesive applied at equal intervals by using, for example, a dispenser. The capillaries 303 are arrayed at equal intervals by arranging the capillaries 303 between the positioning guides 317 formed at the equal intervals. Therefore, the intervals at which the capillaries 303 are arrayed can be changed by changing the intervals of the adhesive applied to the capillary array surface 311.

In the third embodiment, the light transmitting member 307 has a detector installation surface 314. As exemplified in FIG. 10, the detector installation surface 314 is in contact with a device alignment surface 335 of a detector fixing mechanism 334. The detector fixing mechanism 334 is provided in an electrophoresis device, and the substrate presser 136 is used to cause the detector installation surface 314 to come into contact with the device alignment surface 335.

In the third embodiment, a portion located around a quartz tube 315 of the excitation light irradiation section 164 is a sealed structure filled with air, and thus it is possible to reduce a noise signal caused by foreign matter present around the excitation light irradiation section 164, and a sensitivity limit decreases.

### Fourth Embodiment

The first embodiment describes the case where the detector 101 includes the light transmitting plate 106 and the light transmitting member 307. In a case where the light transmitting plate 106 and the light transmitting member 307, which are relatively expensive members, are installed in the capillary array 119 that is a consumable component, the unit price of the capillary array 119 increases and the running cost increases. Therefore, in a fourth embodiment, by installing substitutes for the light transmitting plate 306 and the light transmitting member 307 in an electrophoresis device, the running cost can be suppressed.

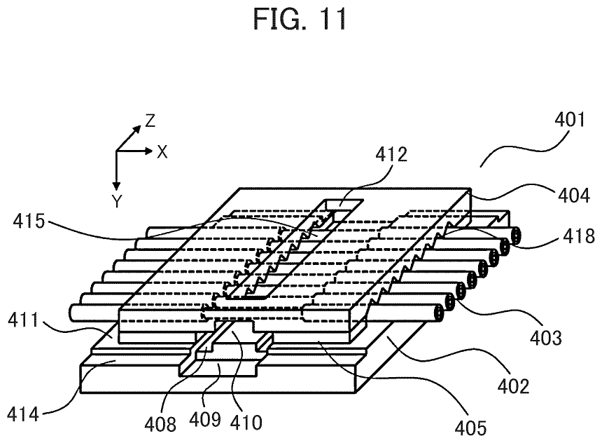

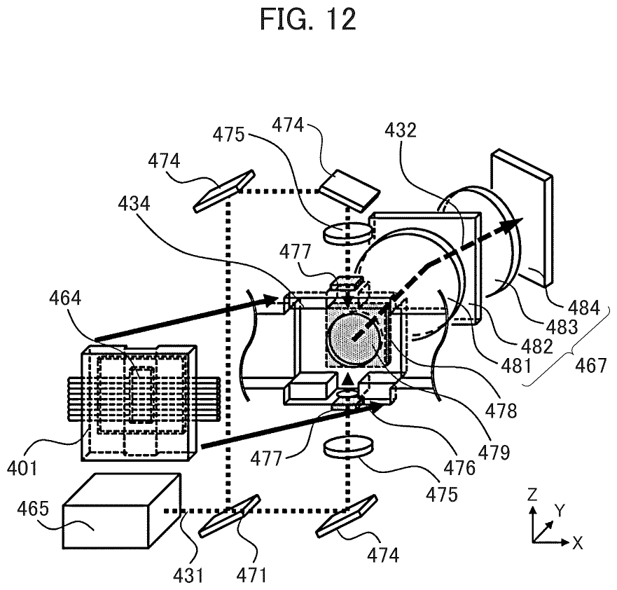

The fourth embodiment will be described with reference to FIGS. 11 and 12. FIG. 11 is a perspective view illustrating a state in which a substrate 402 forming a detector 401 according to the fourth embodiment, a plurality of capillaries 403, and a fixed plate 404 are assembled. FIG. 12 is a perspective view illustrating main components of the electrophoresis device on which the detector 401 is mounted. As in the first embodiment, the substrate 402 has a capillary array surface 411, a detector installation surface 414, an adhesive groove 408, and a recess 409. As in the first embodiment, the fixed plate 404 includes a fluorescence passage opening 412 and a positioning groove 418 and is bonded to the substrate 402 by an adhesive 405.

The electrophoresis device exemplified in FIG. 12 includes a light source 465 and a fluorescence measurement unit 467, as in the first embodiment. An excitation light 431 emitted from the light source 465 is divided into two excitation lights by a half mirror 471. The two excitation lights pass through a plurality of mirrors 474 and a plurality of condensing lenses 475 and then pass through excitation light output holes 476 (at two of upper and lower positions). The excitation light output holes 476 are provided in a detector fixing mechanism 434 on which the detector 401 is mounted. The excitation light output holes 476 have excitation light transmission windows 477. When the detector 401 is mounted on the detector fixing mechanism 434, the excitation light transmission windows 477 are fixed onto the recess 409 of the detector 401, and the excitation light irradiation section 464 is irradiated with the excitation lights that have passed through the excitation light transmission windows 477. That is, the excitation light transmission windows 477 are substitutes for the light transmitting member 307.

Fluorescence 432 emitted from the excitation light irradiation section 464 due to the irradiation with the excitation lights passes through a fluorescence transmission window 478 provided in a fluorescence input holes 479, and is measured by the fluorescence measurement unit 467. That is, the fluorescence transmission window 478 is a substitute for the light transmitting plate 306. The fluorescence measurement unit 467 includes a fluorescence condensing lens 481, a transmission diffraction grating 482, an imaging lens 483, and a two-dimensional CCD 484.

According to the fourth embodiment, the light transmitting plate 106 and the light transmitting member 307, which are relatively expensive members, are not installed in the capillary array 119 that is a consumable component, and thus the running cost can be suppressed. Also in the fourth embodiment, a portion located around a quartz tube 415 of the excitation light irradiation section 164 is a sealed structure filled with air, and thus it is possible to reduce a noise signal caused by foreign matter present around the excitation light irradiation section 164, and a sensitivity limit decreases, as in the first embodiment.

The embodiments of the present invention have been described above. The present invention is not limited to the above-described embodiments and the constituent elements may be modified without departing from the gist of the present invention. In addition, two or more of the constituent elements disclosed above in the embodiments may be combined as appropriate. Further, some constituent elements among all the constituent elements described above in the embodiments may be removed.

### List of Reference Signs

101, 201, 301, 401 . . . detector, 102, 202, 302, 402 . . . substrate, 103, 203, 303, 403 . . . capillary, 104, 204, 404 . . . fixed plate, 105, 205, 405 . . . adhesive, 106, 206, 306 . . . light transmitting plate, 107, 207, 307 . . . light transmitting member, 108, 208, 308, 408 . . . adhesive groove, 109, 209, 409 . . . recess, 110, 210, 310, 410 . . . excitation light neighboring surface, 111, 211, 311, 411 . . . capillary array surface, 112, 212, 312, 412 . . . fluorescence passage opening, 113, 213, 313 . . . protruding light shielding section, 114, 214, 314, 414 . . . detector installation surface, 115, 215, 315, 415 . . . quartz tube, 116 . . . surplus adhesive, 117 . . . adhesive fluorescence, 118, 418 . . . positioning groove, 119 . . . capillary array, 163, 172, 173, 331, 431 . . . excitation light, 132, 332, 432 . . . fluorescence, 133, 335 . . . device alignment surface, 134, 334, 434 . . . detector fixing mechanism, 136, 336 . . . substrate presser, 152 . . . cathode, 153 . . . sample introduction section, 154, 159 . . . buffer solution, 155 . . . cathode-side buffer solution container, 156 . . . valve, 157 . . . gel block, 158 . . . earth electrode, 160 . . . anode-side buffer solution container, 161 . . . syringe, 164, 464 . . . excitation light irradiation section, 165, 465 . . . light source, 167, 467 . . . fluorescence measurement unit, 168 . . . constant-temperature bath, 169 . . . voltage source, 170 . . . capillary head, 171, 471 . . . half mirror, 174, 474 . . . mirror, 175, 475 . . . condensing lens, 181 . . . separator, 182 . . . capillary holder, 183 . . . electrode holder, 185 . . . separator holder, 316 . . . light shielding member, 320 . . . light transmitting member alignment surface, 476 . . . excitation light output hole, 477 . . . excitation light transmission window, 478 . . . fluorescence transmission window, 479 . . . fluorescence input hole, 481 . . . fluorescence condensing lens, 482 . . . transmission diffraction grating, 483 . . . imaging lens, 484 . . . two-dimensional CCD.

1. An electrophoresis device comprising:
a capillary array in which capillaries to be used for electrophoresis of a sample are arrayed in a plane;
an excitation light source that emits excitation light to the capillary array; and
a fluorescence measurement unit that measures fluorescence induced from the capillary array, wherein
the capillary array has a sealed structure in which a portion located around an excitation light irradiation section that is irradiated with the excitation light is filled with air.

2. The electrophoresis device according to claim 1, wherein
in a substrate on which the capillary array is arranged and fixed by an adhesive, a groove is provided between an application section to which the adhesive is applied and the excitation light irradiation section.

3. The electrophoresis device according to claim 2, wherein
a light shielding section that shields light is provided between the groove and the fluorescence measurement unit.

4. The electrophoresis device according to claim 2, wherein
the substrate is constituted by a non-light transmitting member through which light does not pass.

5. An electrophoresis device comprising:
a capillary array in which capillaries to be used for electrophoresis of a sample are arrayed in a plane;
an excitation light source that emits excitation light to the capillary array; and
a fluorescence measurement unit that measures fluorescence induced from the capillary array, wherein
in a substrate on which the capillary array is arranged and fixed by an adhesive, a groove is provided between an application section to which the adhesive is applied and an excitation light irradiation section that is irradiated with the excitation light.

6. A capillary array in which capillaries to be used for electrophoresis of a sample are arrayed in a plane, the capillary array having a sealed structure in which a portion located around an excitation light irradiation section that is irradiated with excitation light is filled with air.
